(19) United States
(12) Patent Application Publication
(10) Pub. No.: US 2013/0063553 A1
(43) Pub. Date: Mar. 14, 2013

(54) Panoramic Optic Clear Enclosure

(71) Applicants: Michael Rondinelli, Canonsburg, PA (US); Michael Barthelemy, Canonsburg, PA (US); Chang Glasgow, Canonsburg, PA (US)

(72) Inventors: Michael Rondinelli, Canonsburg, PA (US); Michael Barthelemy, Canonsburg, PA (US); Chang Glasgow, Canonsburg, PA (US)

(21) Appl. No.: 13/611,715

(22) Filed: Sep. 12, 2012

Related U.S. Application Data
(60) Provisional application No. 61/533,954, filed on Sep. 13, 2011.

(51) Int. Cl. H04N 7/00

(52) U.S. Cl. 348/36

(57) ABSTRACT

An apparatus includes a panoramic optical component shaped to direct light toward a camera; and an enclosure having a transparent portion, the transparent portion being configured such that only light entering the transparent portion in a direction substantially normal to a surface of the transparent portion is transmitted to the panoramic optical component.

### CROSS-REFERENCE TO A RELATED APPLICATION

The application claims the benefit of U.S. Provisional Patent Application Ser. No. 61/533,954, filed Sep. 13, 2011, which is hereby incorporated by reference.

### FIELD OF THE INVENTION

The present invention relates to an apparatus for panoramic imaging.

### BACKGROUND INFORMATION

Optical components used in imaging devices or systems can be housed in external enclosures, or cases, to provide increased ruggedness by shielding the optical components from direct contact with debris and the elements. Such enclosures can be used to facilitate easier or safer cleaning, or as disposable parts to maintain clean images between uses. In an example panoramic imaging device, an external case can also be used as a support structure for a mirror in lieu of an internal support structure such as the stage and post design described in U.S. Pat. No. 7,399,095. External enclosures can also be used in combination with panoramic annular lenses, and other panoramic imaging optics.

Under certain lighting conditions, a panoramic optic assembly having a clear cylindrical or conic shell enclosure will produce glare artifacts. These glare artifacts are most noticeable in regions where the angle of incidence, for light striking the enclosure prior to entering the camera's lens, is highest.

### SUMMARY OF THE INVENTION

In one aspect, the invention provides an apparatus including a panoramic optical component shaped to direct light toward a camera; and an enclosure having a transparent portion, the transparent portion being configured such that only light entering the transparent portion in a direction substantially normal to a surface of the transparent portion is transmitted to the panoramic optical component.

In another aspect, the invention provides an apparatus including a camera, a panoramic optical component shaped to direct light toward the camera; and an enclosure including a transparent portion, the transparent portion being configured such that only light entering the transparent portion in a direction substantially normal to a surface of the transparent portion is transmitted to the panoramic optical component.

### BRIEF DESCRIPTION OF THE DRAWINGS

FIG. 1 is a schematic representation of portions of a panoramic camera system that includes an enclosure having a transparent portion.

FIGS. 2-6 are schematic representations of portions of a panoramic camera system.

FIGS. 7-9 are diagrams that illustrate the operation of a panoramic camera system.

FIG. 10 is a schematic representation of a panoramic camera system that includes an enclosure having a transparent portion.

FIGS. 11-13 are schematic representations of portions of panoramic camera systems that include an enclosure having a transparent portion.

### DETAILED DESCRIPTION

In one aspect, the present invention provides an assembly for use in or with a panoramic imaging device or system configured to reduce the amount of glare in images captured by the device or system. A reduction in glare can be achieved by using a transparent enclosure or case in combination with a reflector, mirror or other panoramic optical component configured such that light directed toward a camera lens first passes through the enclosure at substantially right angles.

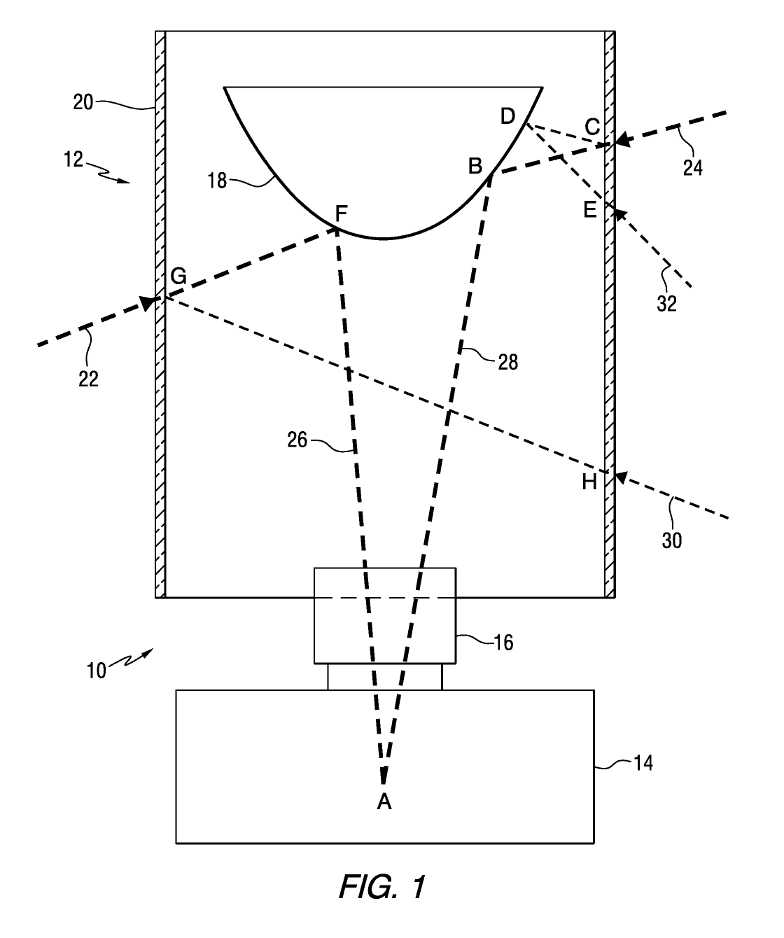

FIG. 1 is a schematic representation of portions of a traditional panoramic imaging system 10 that includes a panoramic optic 12. The system images into a camera 14 having an appropriate standard lens 16. The panoramic optic 12 includes a reflector 18 mounted in a enclosure 20 that is at least partially transparent. Rays of light such as 22 and 24 pass through the transparent enclosure, reflecting on the reflector to produce incident rays 26 and 28, which are focused by the lens into the camera. Since the transparent enclosure is at least partially reflective, undesired rays of light can contribute to the incident rays.

For example, incident ray 26 will include a reflection of light ray 30, which passes through the far side of the enclosure (at point H), passing through the center axis of the cylinder to reflect off of the interior of the enclosure at point G, which coincides with the desired path of light 22. This will appear in the image as glare. This comprises a category of undesirable stray light which always passes through the center of the cylinder.

Additionally, the incident ray 28 will also experience glare. Light from ray 32 passes through the enclosure at point E, then reflects along off of the reflective mirror surface at point D, with a secondary reflection at point C, which coincides with the desired path of light 245. This comprises a second category of undesirable stray light which includes at least one secondary reflection off of the primary reflector.

One possible apparatus for mounting a panoramic mirror includes an optically clear cylinder or substantially cylindrical shape that supports the mirror externally. The mechanical benefits of such a design are great strength and rigidity, making it well suited to applications on moving vehicles where vibration is a concern with other kinds of mounts. Additionally, by fully enclosing the front surface mirror, the cylinder protects the more delicate mirror from external elements, such as weather, dust or debris.

However, a clear cylinder around the mirror can have a negative impact on the resulting image quality from such a system due to glare. While for traditional lenses glare is often reduced by applying thin-film anti-reflective coatings to the appropriate optical surfaces, doing so for a cylinder is often impractical. It is difficult to coat the inside of a cylinder with traditional processes. When used with a panoramic optic, the incident angle of light varies across the length of the cylinder, which would require a variable thickness to the thin-film coatings to preserve its effectiveness. This is technically challenging to manufacture.

A need exists for an alternative solution. By inserting an opaque, black center spike below the mirror, glare that would result from reflected rays of light passing through the center of the cylinder is mitigated. This largely eliminates glare in the reflected image that occurs below the horizon line of the mirror. Further, the remaining glare evident in the image results from reflected rays bouncing off of the surfaces of the cylinder, back to the mirror surface, and then out again at a different incident angle than the original reflection. By adding a curvature to the cylinder such that the incident angle of light is always perpendicular to the surface, the secondary reflections are directed back in the same direction they started from, which should effectively cancel the undesired reflection. This technique can be applied to panoramic mirrors of most any geometry to improve image quality.

In various embodiments, an optic assembly having a case or enclosure with a transparent portion is provided such that light entering the camera's lens first passes through the transparent portion of the enclosure at substantially right angles to reduce the amount of glare in the final image. The enclosure surface can be designed such that the path of incident of interest is normal (i.e., perpendicular) to the surface of the transparent portion of the enclosure at all points. Such an enclosure may still have undesired reflections, but by shaping the surface such that incident light rays of interest are normal to the enclosure surface, the reflections are directed back at the source of the light, and therefore do not directly contribute to glare in the image.

The transparent portion of the enclosure is shaped or configured such that only light that strikes the transparent portion at a substantially right angle passes to the mirror or reflector. That is, the surface of the transparent portion of the enclosure is shaped such that all the desired light will follow a path through the surface at a normal angle. Doing so eliminates the category of glare which results from reflections at this point on the interior surface of the transparent portion of the enclosure. The margin of error is determined by the size of the aperture into the camera system. For example assuming a pinhole camera, ray tracing will show that only the normal incident rays will affect the image. Real optical systems have a finite iris, however, and rays slightly offset from normal may affect the image. The rays that are substantially normal to the surface of the transparent portion of the enclosure contribute to the image captured by the camera.

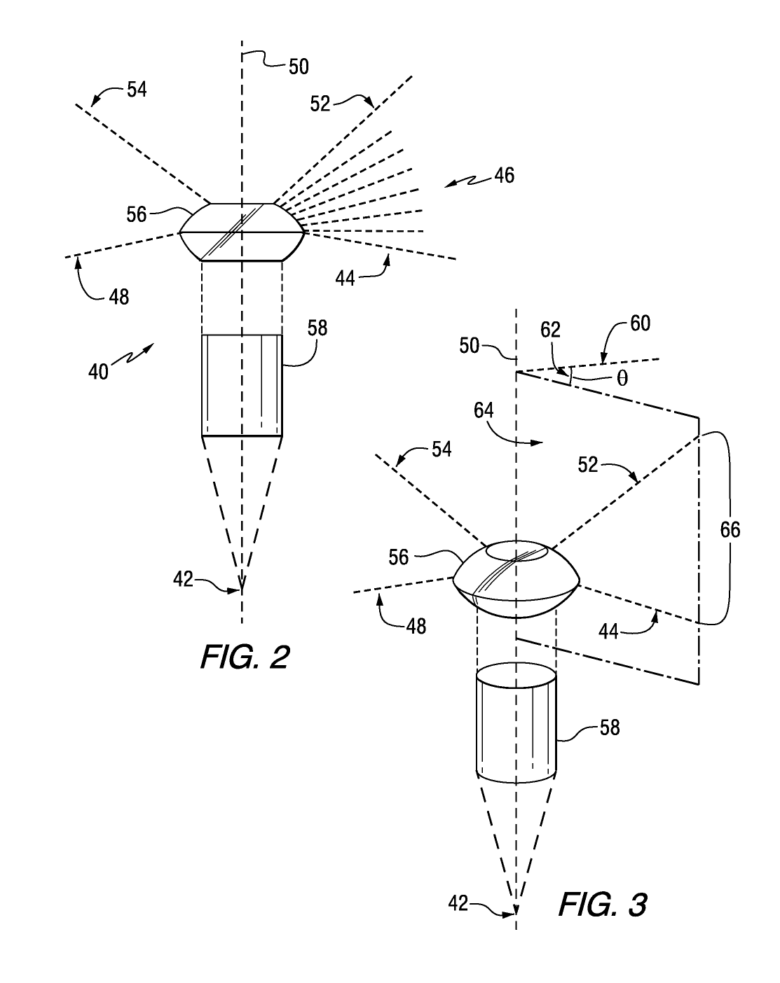

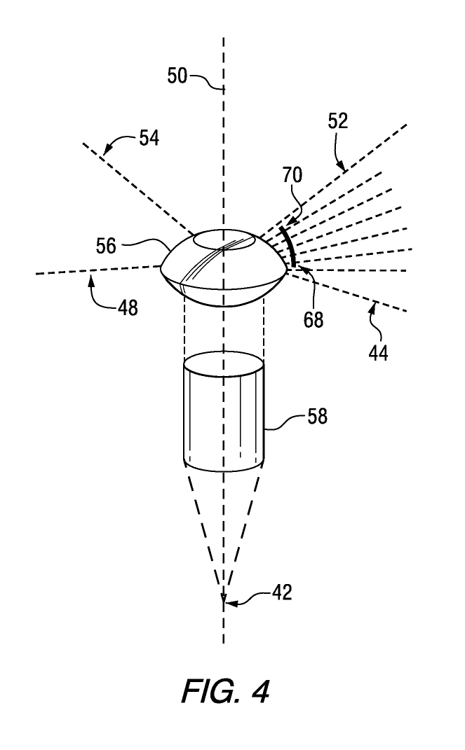

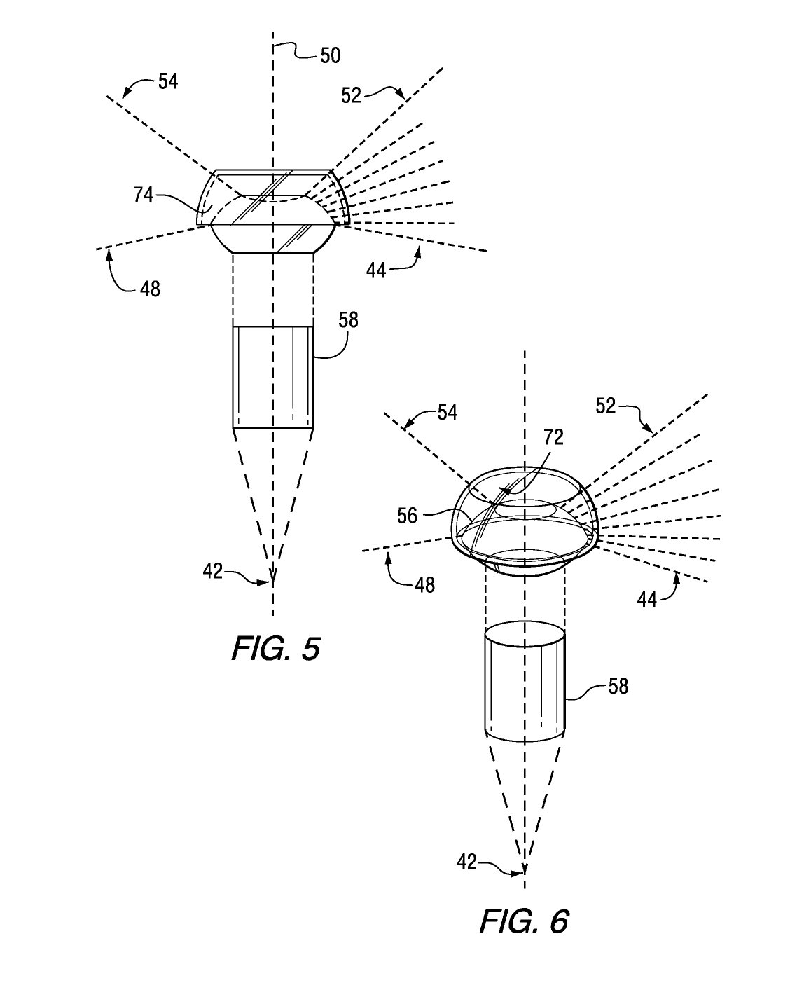

FIGS. 2-6 are schematic drawings that can be used to illustrate a method for determining the shape of the transparent portion of an enclosure that can be used in an embodiment of the invention.

For the purposes of this description, the following definitions apply. A panoramic imaging system means an apparatus, device, or system that includes a camera or other image capturing device and a panoramic optic assembly that directs light to the camera or other image capturing device. A panoramic optic assembly is a device that directs light into a camera or other image capturing device. An initial component is the first effective optical component that receives light that can be used to construct a panoramic image. For example, the initial component can be a lens in the case of a Panoramic Annular Lens, or a reflective surface (e.g., a mirror) in another embodiment. In some embodiments, the initial component can be at least a portion of an enclosure that is positioned to transmit light to a reflector. Relevant light is light that enters the panoramic optic assembly and is directed toward the camera or other image capturing device. A primary axis is a line corresponding to the average vector of relevant light after passing through, or being reflected by, the initial component. In a radially symmetric optic, this would also be the axis of radial symmetry.

FIGS. 2-6 are schematic representations of elements of an optic assembly 40. FIGS. 2-6 can be used to illustrate a generalized method of determining a shape of a transparent portion of an enclosure to be used in combination with an initial component in the form of a Panoramic Annular Lens.

In FIGS. 2-6 item 42 is a camera location; item 44 is a lower vertical boundary for relevant light 46; item 48 is the lower vertical boundary for relevant light as it is rotated 180° about a central axis 50; item 52 is an upper vertical boundary for relevant light; item 54 is the upper vertical boundary for relevant light as it is rotated 180° about 50; item 56 is an initial component (i.e., a Panoramic Annular Lens in this example); item 58 represents additional optical components (as needed or desired); item 60 is an arbitrary vector representing an angle θ value of 0; item 62 is the angle θ; item 64 is a plane that intersects the central axis and is offset from the arbitrary vector 60 by an angle θ; item 66 is the slope field f(θ); item 68 is an arbitrary point offset from the initial component 56; item 70 is curve, referred to as curve₀; item 72 is a surface produced by extending curve₀; and item 74 shows a uniform thickness of the transparent portion of the enclosure.

To determine a desired shape of the initial component, the following method can be used. Let θ represent an arbitrary angle of rotation 62 about the primary axis 50. Begin by determining the function, f(θ), mapping any value of θ to the slope field for relevant light as it enters the transparent portion of the enclosure in the plane that passes through the primary axis and is positioned an angle θ. A slope field (also called a vector field or a direction field) is a tool to graphically obtain the solutions to a first order differential equation. Note that for a radially symmetric optic assembly, the slope field returned by the function f(θ) is the same for all values of θ.

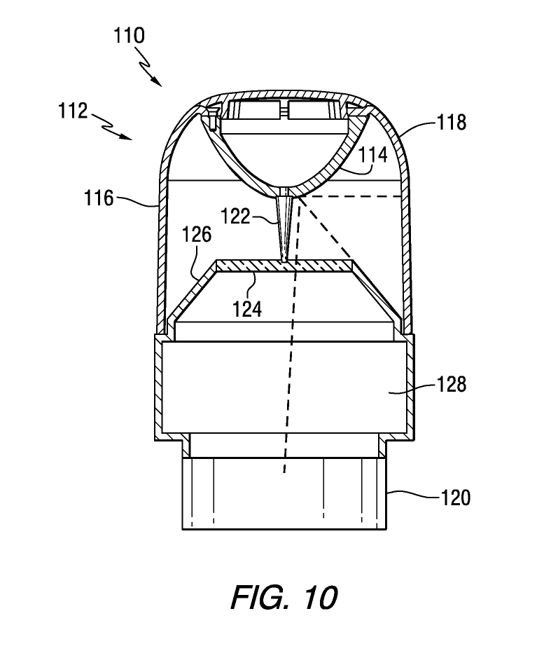

Select an arbitrary point 68 offset from the initial component to use as the start point of the enclosure, refer to this point as p₀. Determine the value of θ corresponding to p₀, refer to this value as θ₀. Extend p₀ into a curve 70 by following the orthogonal vectors of f(θ₀), stopping at the edge of the slope field or when a mechanical component is encountered, refer to this curve as curve₀. Extend curve₀ into a surface 72 by following the orthogonal vectors of f(θ) for incremental values of θ. Note that in the case of radially symmetric optics, curve₀ can be extended into the appropriate surface by rotating it about the primary axis. To arrive at the final enclosure, apply a uniform thickness to the exterior side of the surface. The initial component is the first element in the optical system before the enclosure is added. The existing optical system is used to determine the shape of the transparent portion of the enclosure, based on an arbitrary starting point. By using an “arbitrary” starting point, a designer can choose any point that is convenient mechanically to start the enclosure. For the apparatus in FIG. 10 for example, a point a couple millimeters away from the upper edge was chosen to provide clearance for assembly.

For use with optic assemblies similar to those described in U.S. Pat. Nos. 7,399,095 and 6,856,472, which are incorporated herein by reference, a simpler method can be used.

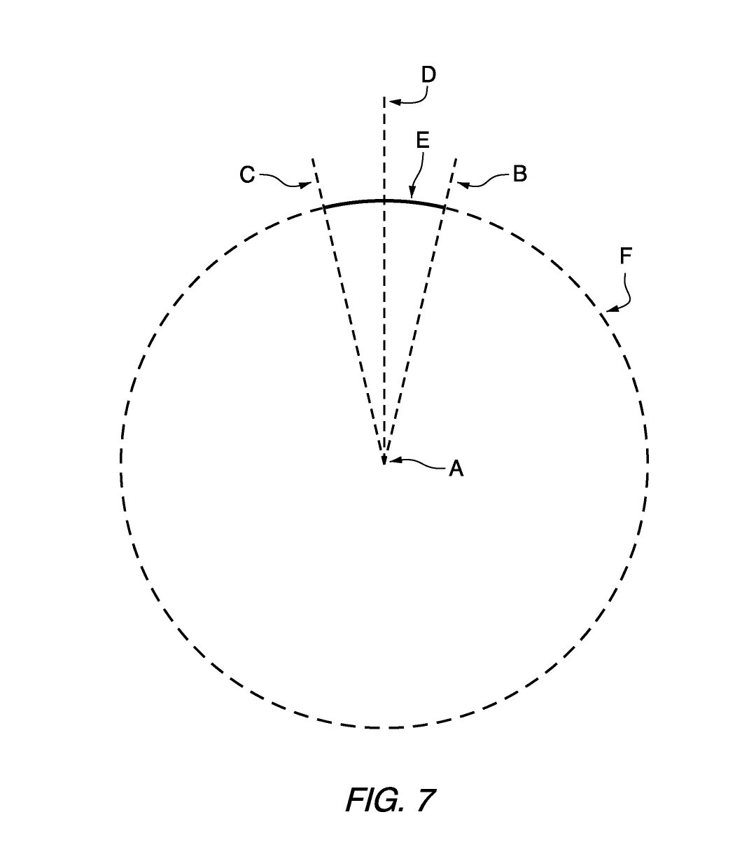

FIGS. 7-9 are diagrams that illustrate the configuration of another enclosure for use in a panoramic camera system. In FIG. 7, the vector AB defines the axis of a camera positioned at point A. Let the vectors AB and AC define the field of view of the camera A; let F define a circle of arbitrary radius, for which A is the center; and let E define the arc segment of F that lies in the field of view of the camera.

Assume that all lines entering a circle and passing through the center of that circle enter at a right angle. Lines coincident with A and passing through E must then pass through E at right angles. Then, light passing through a spherical segment formed by rotating E about the vector AD will always do so at a right angle if that light is to enter the camera at point A.

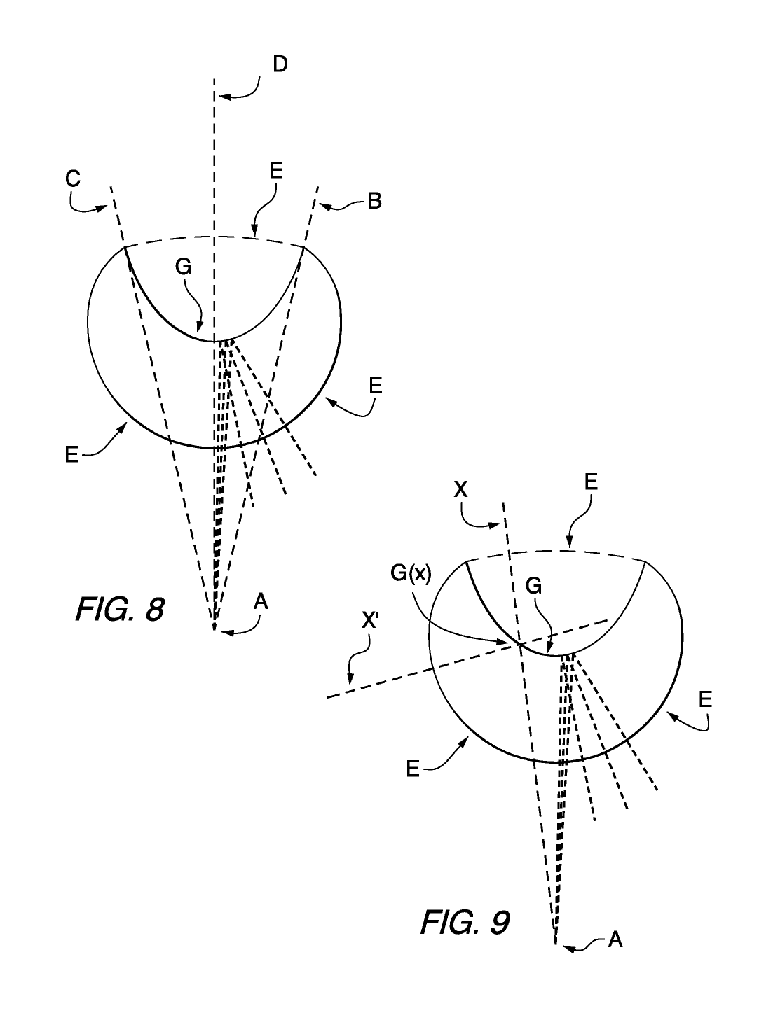

Referring to FIGS. 8 and 9: Let items A-E be defined as in FIG. 7; let G define the cross section of a panoramic mirror that spans the entire field of view of the camera A; let E′ define E, mirrored across G; let x define any line coincident with A and passing through G; and let G(x) define the intersection of x and G.

Then for any line x, there exists a line x′, representing the reflection of x across the tangent of G at G(x). From FIG. 9, it is shown that x must necessarily also pass through E, and do so at a right angle. Since E′ is the mirror of E across G, then x′ must then pass through E′, and do so at the same angle with which x passes through E, i.e., a right angle.

To avoid refraction and reflection artifacts from light passing through the enclosure multiple times, the enclosure should be trimmed to exclude the field of view of the camera as demonstrated in FIG. 10. To form an enclosure which can be more easily manufactured, part(s) of the E′ curve can be truncated and replaced with linear segments at some cost to its glare reduction capabilities. FIGS. 8 and 9 demonstrate one such modification, where the linear line segment is tangent to the E′ curve it extends. In such designs, the introduction of an opaque cone matching the camera's reflected (about G) field of view can further reduce glare artifacts in the linear segment.

FIG. 10 is a schematic representation of portions of a panoramic imaging system 110 that includes a panoramic optic assembly 112 including a reflector 114 mounted in an enclosure or case 116. At least a portion 118 of the enclosure is transparent. Light that passes through the transparent portion of the enclosure is reflected by the reflector toward a camera 120. In this embodiment, the reflector is supported by a post 122 that extends from a transparent member 124. An opaque truncated cone 126 is provided in a region outside of the reflected field of view. Additional optical elements 128 can be included between the reflector and the camera. The transparent portion can be shaped to conform to a computed curve as described above. In this embodiment, the initial component can be a mirror of the form described in U.S. Pat. No. 7,399,095.

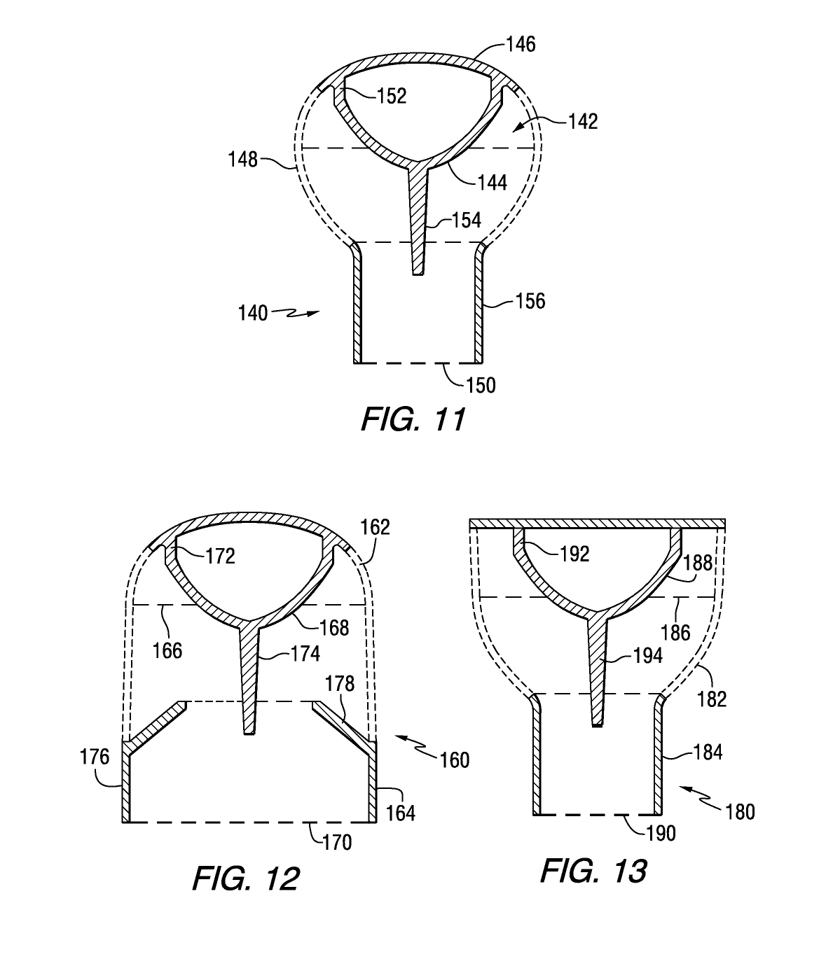

FIG. 11 is a schematic representation of portions of a panoramic imaging system 140 that includes a panoramic optic 142 including a reflector 144 mounted in an enclosure or case 146. At least a portion 148 of the enclosure is transparent. Light that can be used to produce a image or video of a scene passes through the transparent portion of the enclosure is reflected by the reflector toward a camera, not shown in this view, that can be positioned to receive light reflected by the reflector toward the end 150 of the enclosure. The transparent portion of the enclosure is configured such that only incident light that strikes the transparent portion of the enclosure at substantially a right angle passes to the reflector. In this embodiment, the reflector is mounted in a fixed position in the enclosure by support structure 152. An opaque rod 154 is positioned along a central axis of the assembly. The opaque rod is tapered such that its cross-sectional area decreases in a direction away from the reflector. The length and width of the tapered rod are sufficient to block light from passing through the enclosure near the central axis. As described with respect to FIG. 1, if not blocked, such light might contribute to glare if it is reflected toward the reflector by an internal surface of the enclosure. In this embodiment, the opaque rod extends from the reflector to a point below the transparent portion of the enclosure, and ends within a non-transparent portion 156 of the enclosure.

Additional optical elements, not shown in this view, can be included between the reflector and the camera. As used in this description, a camera includes any type of image capture or video capture device. Light will pass through the enclosure at other angles, but will not ultimately contribute to the image formed by the camera. This can be established by ray tracing from the center of the camera projection out and evaluating all the reflections and refractions that may occur along the way.

FIG. 12. is a schematic representation of portions of a panoramic imaging system 160 similar to that of FIG. 11, where the transparent portion 162 of the enclosure 164 is configured such that incident light strikes at substantially a right angle for angles above a horizontal plane 166. The horizontal plane may be determined by the rays of incident light onto the reflector at substantially a 90 degree angle from the axis of radial symmetry, or by a plane whose rays of incident light are within 5 degrees of this horizon. This embodiment allows for the enclosure to be more easily manufactured using a core-cavity injection molding process, because the curvature does not feature any concavity or “undercuts” which would otherwise make it impossible to eject the part from the mold after injection. It is optimized for circumstances where most glare inducing light may come from above the optic. Light that can be used to produce a image or video of a scene passes through the transparent portion of the enclosure is reflected by the reflector 168 toward a camera, not shown in this view, that can be positioned to receive light reflected by the reflector toward the end 170 of the enclosure. The transparent portion of the enclosure (above the horizontal plane) is configured such that only incident light that strikes the transparent portion of the enclosure at substantially a right angle passes to the reflector. In this embodiment, the reflector is mounted in a fixed position in the enclosure by support structure 172. An opaque rod 174 is positioned along a central axis of the assembly. The opaque rod is tapered such that its cross-sectional area decreases in a direction away from the reflector. The length and width of the tapered rod are sufficient to block light from passing through the enclosure near the central axis. As described with respect to FIG. 1, if not blocked, such light might contribute to glare if it is reflected toward the reflector by an internal surface of the enclosure. In this embodiment, the opaque rod extends from the reflector to a point below the transparent portion of the enclosure, and ends within a non-transparent portion 176 of the enclosure. An opaque truncated cone 178 is provided in a region outside of the reflected field of view.

FIG. 13 is a schematic representation of portions of a panoramic imaging system 180 similar to that of FIG. 11, where the transparent portion 182 of the enclosure 184 is configured such that incident light strikes at substantially a right angle for angles below a horizontal plane 186. The horizontal plane may be determined by the rays of incident light onto the reflector at substantially a 90 degree angle from the axis of radial symmetry, or by a plane whose rays of incident light are within 5 degrees of this horizon. This embodiment allows for the enclosure to be more easily manufactured using a core-cavity injection molding process, because the curvature does not feature any concavity or “undercuts” which would otherwise make it impossible to eject the part from the mold after injection. It is optimized for circumstances where most glare inducing light may come from below the optic. Light that can be used to produce a image or video of a scene passes through the transparent portion of the enclosure is reflected by the reflector 188 toward a camera, not shown in this view, that can be positioned to receive light reflected by the reflector toward the end 190 of the enclosure. The transparent portion of the enclosure (below the horizontal plane) is configured such that only incident light that strikes the transparent portion of the enclosure at substantially a right angle passes to the reflector. In this embodiment, the reflector is mounted in a fixed position in the enclosure by support structure 192. An opaque rod 194 is positioned along a central axis of the assembly. The opaque rod is tapered such that its cross-sectional area decreases in a direction away from the reflector. The length and width of the tapered rod are sufficient to block light from passing through the enclosure near the central axis. As described with respect to FIG. 1, if not blocked, such light might contribute to glare if it is reflected toward the reflector by an internal surface of the enclosure. In this embodiment, the opaque rod extends from the reflector to a point below the transparent portion of the enclosure, and ends within a non-transparent portion 176 of the enclosure.

In each of the disclosed embodiments, the panoramic optical component can be a radially symmetric component. In addition, the enclosure can be a radially symmetric enclosure.

In the various described embodiments, the transparent portion of the enclosure is designed to have a uniform thickness in order to avoid refraction of light passing through it. The portion of the enclosure which is intended to transmit light may be constructed of any material that is substantially transparent at the desired wavelengths, such as polycarbonate or acrylic plastics and various forms of glass or quartz for visible light. Other materials may be considered for applications in other parts of the spectrum. The transmission of the enclosure may be improved through the use of one or more thin film antireflective coatings on the transparent portion, which may be simpler to apply to the curved enclosure shape.

Whereas particular embodiments of this invention have been described above for purposes of illustration, it will be evident to those skilled in the art that numerous variations of the details of the described embodiments may be made without departing from the invention.

1. An apparatus comprising:
a panoramic optical component shaped to direct light toward a camera; and
an enclosure including a transparent portion, the transparent portion being configured such that only light entering the transparent portion in a direction substantially normal to a surface of the transparent portion is transmitted to the panoramic optical component.

2. The apparatus of claim 1, further comprising:
an opaque rod positioned along an axis between the panoramic optical component and the camera.

3. The apparatus of claim 2, wherein the opaque rod is tapered such that its cross-sectional area decreases in a direction away from the panoramic optical component.

4. The apparatus of claim 2, wherein a length and width of the opaque rod are sufficient to block light from passing through the enclosure near the axis.

5. The apparatus of claim 1, wherein the transparent portion has a uniform thickness.

6. The apparatus of claim 1, wherein the transparent portion is positioned below a horizontal plane, the plane determined by rays of incident light onto the panoramic optical component at substantially a 90 degree angle from an axis of radial symmetry, or by a plane whose rays of incident light are within 5 degrees of the horizontal plane.

7. The apparatus of claim 1, wherein the transparent portion is positioned above a horizontal plane, the plane determined by rays of incident light onto the panoramic optical component at substantially a 90 degree angle from an axis of radial symmetry, or by a plane whose rays of incident light are within 5 degrees of the horizontal plane.

8. The apparatus of claim 1, further comprising:
an opaque truncated cone in the enclosure.

9. The apparatus of claim 8, wherein the opaque truncated cone is positioned in a region outside of a reflected field of view of the panoramic optical component.

10. The apparatus of claim 1, wherein the panoramic optical component is mounted within the enclosure.

11. The apparatus of claim 1, wherein the enclosure includes an opaque portion.

12. The apparatus of claim 1, wherein the panoramic optical component and the enclosure are each radially symmetric.

13. The apparatus of claim 1, wherein the transparent portion comprises:
a material that is substantially transparent at desired wavelengths of incident light.

14. The apparatus of claim 1, wherein the transparent portion comprises one of:
polycarbonate or acrylic plastics; glass; or quartz.

15. The apparatus of claim 1, further comprising:
a thin film antireflective coating on the transparent portion.

16. The apparatus of claim 1, wherein the panoramic optical component comprises one of:
a panoramic annular lens or a reflector.

17. An apparatus comprising:
a camera;
a panoramic optical component shaped to direct light toward the camera; and
an enclosure including a transparent portion, the transparent portion being configured such that only light entering the transparent portion in a direction substantially normal to a surface of the transparent portion is transmitted to the panoramic optical component.

18. The apparatus of claim 17, further comprising:
an opaque rod positioned along an axis between the panoramic optical component and the camera.

19. The apparatus of claim 18, wherein a length and width of the opaque rod are sufficient to block light from passing through the enclosure near the axis.
